(19) United States
(12) Patent Application Publication
(10) Pub. No.: US 2025/0274489 A1
(43) Pub. Date: Aug. 28, 2025

(54) SECURITY SERVICE DISTRIBUTION

(71) Applicant: Cisco Technology, Inc., San Jose, CA (US)

(72) Inventors: Flemming S. Andreasen, Marlboro, NJ (US); Robert Edgar Barton, Richmond (CA); Saravanan Radhakrishnan, Bangalore (IN)

(21) Appl. No.: 18/586,084

(22) Filed: Feb. 23, 2024

(51) Int. Cl. H04L 9/40

(52) U.S. Cl. CPC H04L 63/20; H04L 63/0245

(57) ABSTRACT

This disclosure describes techniques for distributing security service by performing security policy-based routing among network devices. The techniques include determining a security function to be applied to a packet of a data traffic flow. The security function may be determined based on a security policy and an intended destination of the packet. The techniques may also include determining whether a network device is capable of performing the security function. A route for the packet to the destination may be determined based on whether the network device is capable of performing the security function. As such, distributing security service techniques may improve efficiency in data traffic routing, and may reduce cost and/or prevent redundancy in security service application.

### TECHNICAL FIELD

The present disclosure relates generally to distributing security service by performing security policy-based routing between a network and the cloud, thereby improving performance of the network.

### BACKGROUND

People now routinely work outside the traditional corporate office. Accordingly, applications and workloads are increasingly moving from the corporate data center to the cloud. As a result, the traditional perimeter-based approach to security is no longer adequate. Secure Access Service Edge (SASE) provides an approach to help address some of the challenges in this new environment. A SASE-based solution may include two parts: a Security Service Edge (SSE), which provides a set of security services in several different points-of-presence (PoPs), as well as a software-defined wide area network (SD-WAN) to interconnect an organization's branches, campus(es), data centers, virtual private clouds (VPCs), etc. The SD-WAN may be connected to the SSE. When traffic needing security services (e.g., firewall (FW), intrusion prevention system (IPS), data loss prevention (DLP), etc.) is sent between different sites, it will traverse the SSE, which may provide those security services. The actual security services required may be determined by policy and orchestration services as part of the SSE. However, sending traffic through the SSE can increase overall latency, since SSE services may be primarily located in the cloud. Also, sending traffic through the SSE and providing security services has an associated cost, such as bandwidth, computation resources, storage, etc.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. In some cases, parentheticals are utilized after a reference number to distinguish like elements. Use of the reference number without the associated parenthetical is generic to the element. The systems depicted in the accompanying figures are not to scale and components within the figures may be depicted not to scale with each other.

FIGS. 1A-2 illustrate component diagrams with example environments in which distributing security service concepts may be employed as part of communications between network devices, in accordance with the present concepts.

FIGS. 3 and 4 illustrate flow diagrams of example methods for the use of distributing security service concepts as a part of communications among network devices, in accordance with the present concepts.

FIG. 5 illustrates a block diagram illustrating an example packet switching system that can be utilized to implement various aspects of the technologies disclosed herein.

FIG. 6 illustrates a block diagram illustrating certain components of an example node that can be utilized to implement various aspects of the technologies disclosed herein.

FIG. 7 illustrates a computing system diagram illustrating a configuration for a data center that can be utilized to implement aspects of the technologies disclosed herein.

FIG. 8 is a computer architecture diagram showing an illustrative computer hardware architecture for implementing a computing device that can be utilized to implement aspects of the various technologies presented herein.

### DESCRIPTION OF EXAMPLE EMBODIMENTS

### Overview

This disclosure describes, at least in part, a method that may be implemented by a controller device communicatively coupled to one or more network devices. The method may include receiving, at the controller device, information regarding a packet sent from a user device to a network device, the information including an intended destination of the packet. The method may include determining, by the controller device, a security function to be applied to the packet based at least in part on a security policy and the intended destination. The method may also include determining, by the controller device, whether the network device is capable of performing the security function. Based on whether the network device is capable of performing the security function, the method may include determining, by the controller device, a route for the packet to the destination. In some examples, the method may further include communicating, by the controller device, the route to the network device.

This disclosure also describes, at least in part, another method that may be implemented by a network device communicatively coupled to a user device and one or more other network devices. The method may include receiving, at the network device, a packet sent from the user device. The method may include determining a destination of the packet. Based at least in part on the destination, the method may include determining a security function to be applied to the packet. The method may also include determining whether the network device is capable of performing the security function. In some examples, the method may include adding information to a header of the packet regarding whether the security function was applied to the packet. Additionally, the method may include forwarding the packet to the destination.

Additionally, the techniques described herein may be performed by a system and/or device having non-transitory computer-readable media storing computer-executable instructions that, when executed by one or more processors, performs the method described above.

### EXAMPLE EMBODIMENTS

This disclosure describes techniques for distributing security service across a network and the cloud. The distribution may leverage security services available in the network and in the cloud. For example, a portion of a security service may be accomplished by security services available in the network, while another portion of the security service is accomplished by security services available in the cloud. Security service distribution may include performing security policy-based routing between the network and the cloud. The distribution of security service across the network and the cloud may be performed in a manner that improves overall efficiency of network operations. For instance, security services available in the network may be leveraged to improve overall latency and reduce cost in network operations, rather than sending all data traffic through a security service in the cloud.

In some examples, the techniques described herein may be viewed as part of implementing a distributed Secure Access Service Edge (SASE) fabric. Security service distribution techniques may include defining a distributed SASE controller. The distributed SASE controller may have access to information about security capabilities of the network (e.g., SD-WAN), SSE security services, security policies, routing paths, and/or other pertinent information. The distributed SASE controller may perform security policy-based routing. The distributed SASE controller may determine whether a given application invocation can bypass the SSE. A determination to bypass the SSE, or another security service or function may be based on the information listed above (e.g., a security policy). In some examples, if the distributed SASE controller determines that the application may not bypass the SSE, the distributed SASE controller may further determine whether one or more of the required security services can be provided by the SD-WAN. In any case, the distributed SASE controller may signal to the SD-WAN and the SSE which security services each need to provide.

In some examples, security service distribution may improve the performance of the network by decreasing overall latency. For instance, having the network perform at least some portion of the security service, as compared to sending all traffic through the SSE, may decrease overall latency since the SSE services are typically primarily located in the cloud. Also, cost to an organization may be reduced by security service distribution through lowering resource use (e.g., usage of bandwidth, computational resources, storage, etc.) as compared to sending all traffic through the SSE. Prior to the present security service distribution techniques, there were limited ways of leveraging the security services supported by the SD-WAN infrastructure (e.g., firewall, etc.). Now, security service distribution techniques may reduce both latency and SSE cost by allowing traffic flows that only require security services provided by the SD-WAN infrastructure to not be sent through the SSE, thereby potentially reducing duplication of services, for example. Further, security service distribution techniques may reduce overall SSE cost by allowing traffic flows that need security services provided by both the SD-WAN and the SSE to leverage the relevant security services in the SD-WAN and the remaining ones in the SSE, in some cases.

Additional security service distribution techniques are contemplated. For instance, security service distribution techniques may be further enhanced by providing in-band signaling and auditing capabilities for the application of desired security services to a given traffic flow, rather than controlling the distribution through a central controller. In some examples, these capabilities may be provided by extending the data plane with in-band signaling information about the security services desired and/or the security services provided. For instance, a security service header may designate specific services that are desired for a given traffic flow.

To summarize, a more efficient technique is presented for ensuring security of data traffic flows for an organization, while also considering efficiency of network performance and conservation of network resources. In some examples, security service distribution may be viewed as a lightweight mechanism for improving network operations, featuring both relatively low computational cost and relatively low bandwidth usage. The present concepts are able to reduce network latency, operational cost, and prevent duplication of services.

Although the examples described herein may refer to a distributed SASE controller (e.g., controller device), the techniques can generally be applied to any device in a network. Further, the techniques are generally applicable for any network of devices managed by any entity where virtual resources are provisioned and/or remote services are accessed. In some instances, the techniques may be performed by software-defined networking (SDN), and in other examples, various devices may be used in a system to perform the techniques described herein. The devices by which the techniques are performed herein are a matter of implementation, and the techniques described are not limited to any specific architecture or implementation.

The techniques described herein provide various improvements and efficiencies with respect to network communications. For instance, the techniques described herein may reduce the amount of computational resource use, storage, dropped data, latency, and other issues experienced in networks due to lack of network resources, overuse of network resources, issues with timing of network communications, and/or improper routing of data. By improving network communications across a network, overall performance by servers and virtual resources may be improved.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

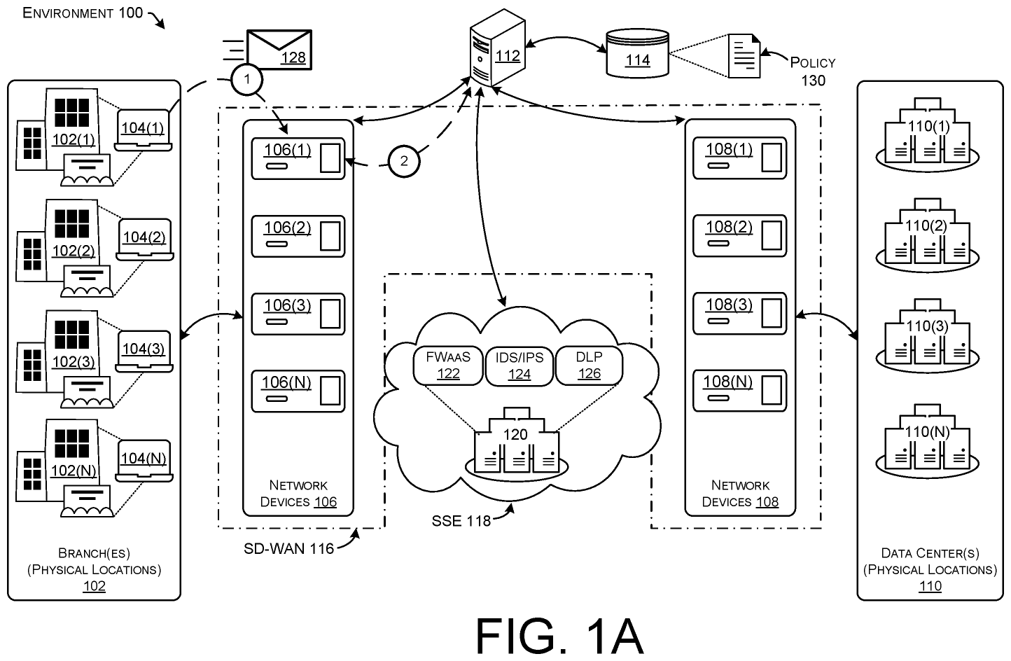

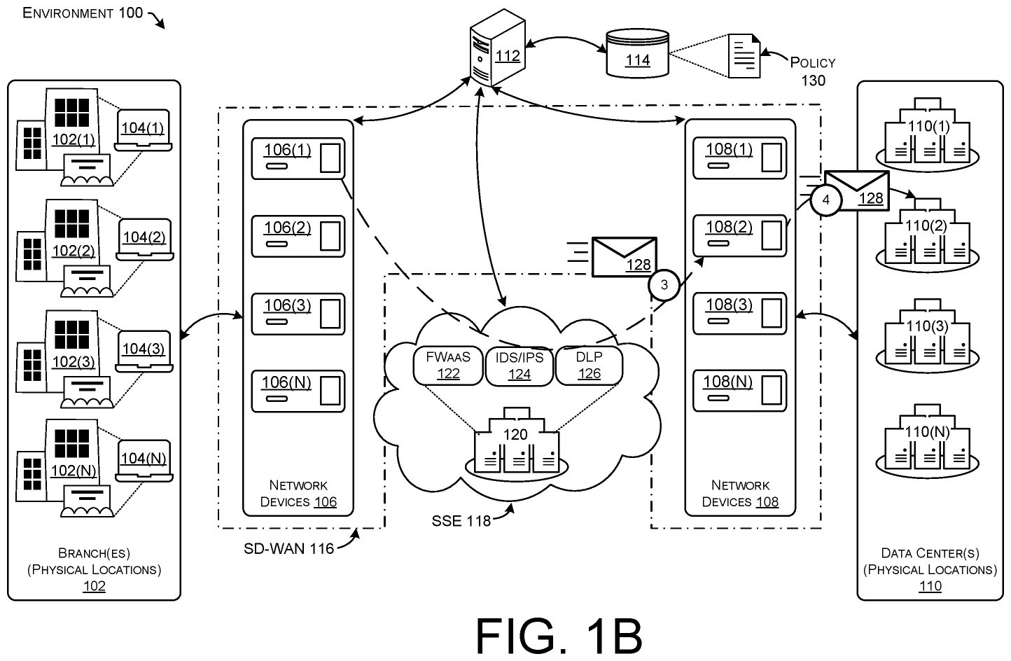

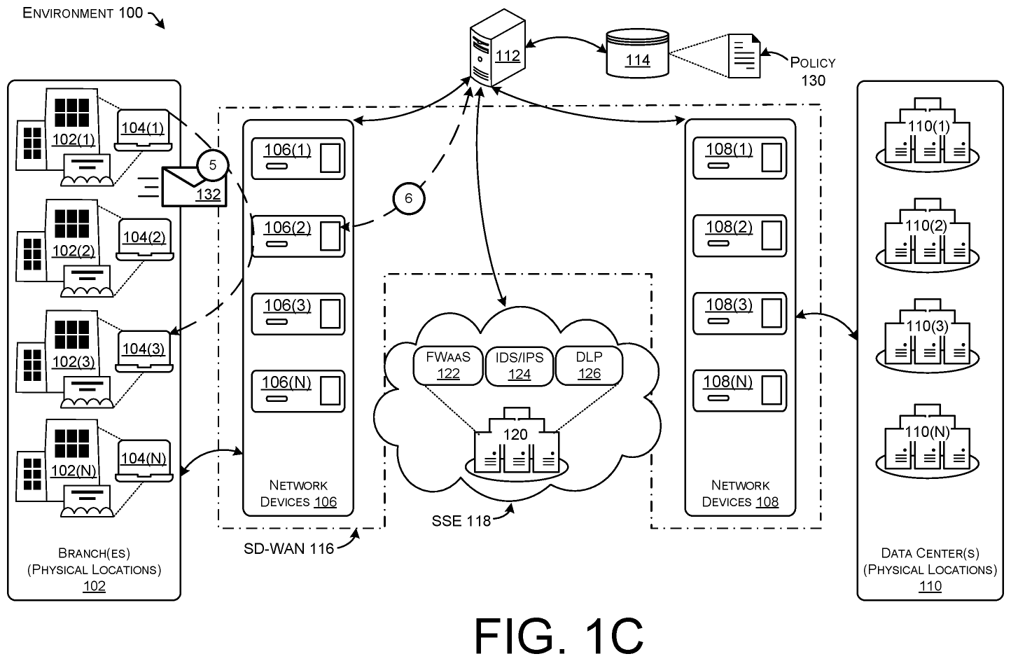

FIGS. 1A-1C collectively illustrate an example environment 100 in accordance with the present security service distribution concepts. Example environment 100 may include branches 102, which may include one or more user devices 104 (e.g., computer, laptop, mobile device, tablet, etc.). Environment 100 may also include one or more network devices 106 and 108 and one or more data centers 110, a controller device 112, and/or a database 114. The network devices 106 and 108 may include any of a variety of computing devices, including switches, routers, edge devices, or other types of computing devices that are part of a network connecting the devices of environment 100. In some cases, parentheticals are utilized after a reference number to distinguish like elements. Use of the reference number without the associated parenthetical is generic to the element. For instance, in FIG. 1A, four branches 102 are depicted, including branch 102(1), branch 102(2), branch 102(3), and branch 102(N). The use of “N,” as in branch 102(N) suggests that any number of the element may be part of environment 100. For illustration purposes, branches 102 may be viewed as physical locations, such as locations of an organization or corporation. The branches 102 may be locations where employees (e.g., users) of an organization work, for instance. The employees may be associated with the user devices 104. The employees and/or user devices 104 may be associated with the branches 102 as their respective physical workplace, or the employees may be associated with a branch 102 while working remotely. Branches 102 may additionally or alternately represent buildings, remote sites, campuses, residences, or any of a variety of physical locations in environment 100.

In some examples, the network devices 106 and/or 108 of environment 100 may be considered part of a software defined wide area network (SD-WAN) 116, indicated by a dashed line. The inclusion or exclusion of various elements of environment 100 within the dashed line as SD-WAN 116 is not meant to be limiting. For instance, SD-WAN 116 may present a virtual network through which a data traffic flow may pass from a user device 104 at a particular branch 102, through one or more network devices 106 to a particular data center 110. In another instance, data traffic flow may be sent from one user device 104 at one branch 102 to another user device 104 at another branch 102. Note that the configuration of the SD-WAN 116, or which devices are considered part of the SD-WAN 116, may change over time. Furthermore, environment 100 may include a security service edge (SSE) 118. The SSE 118 may include one or more server devices 120, and may generally be located in the cloud. In some examples, SSE 118 may be viewed as being external to, or outside of, the SD-WAN 116. The SSE 118 may offer a variety of services, such as firewall as a service (FWaaS) 122, intrusion detection system and/or intrusion prevention system (IDS/IPS) 124, data loss prevention (DLP) 126, and/or other types of services. As such, SSE 118 may represent a variety of different services which may be accessed or utilized by various devices of environment 100. In other examples, SSE 118 may represent a different type of service, such as data collection, various networking functions, etc., which may not be related to security.

Network devices 106 and 108 may be communicatively coupled to various other devices of environment 100, such as user devices 104, data centers 110, controller device 112 and/or server device 120 via network connection(s), some of which are generally represented by double arrows (not designated). Within the example environment 100, any of the devices (e.g., network devices 106 and 108) may exchange communications (e.g., packets) via the network connection(s). For instance, the network connections may be transport control protocol (TCP) network connections or any network connection (e.g., information-centric networking (ICN)) that enable the network devices 106 and 108 to exchange packets with other devices via the network connections. The network connections represent, for example, data paths between the devices of environment 100. It should be appreciated that the term “network connection” may also be referred to as a “network path.” The use of a cloud computing network for SSE 118 in this example is not meant to be limiting. Other types of networks are contemplated in accordance with security service distribution concepts, such as an enterprise system.

FIGS. 1A-1C show several examples of communications between a user device 104 and various other network devices. The communications are indicated with dashed, numbered lines. For example, referring to FIG. 1A, at “Step 1,” user device 104(1) may send a packet 128 to network device 106(1). The packet 128 may be a part of a data traffic flow sent by user device 104(1) to another device in environment 100. For example, an intended destination for the data traffic flow may be data center 110(2).

At “Step 2” of FIG. 1A, communication may occur between network device 106(1) and controller device 112. The communication may relate to packet 128 and/or the data traffic flow sent by user device 104(1). For example, the data traffic flow may be subject to a policy 130. Controller device 112 may access the policy 130 via the database 114, for instance. The policy 130 may be used by controller device 112 to determine security functions to be applied to the data traffic flow.

In a modern computing network, data traffic patterns may generally include flow from branch to branch (or from device to device) within an organization, flow from a branch to data centers in the cloud, or complex combinations of these flows. Security services may be desired throughout the network, but not all security services or functions may be present in all locations. The lack of ubiquitously available security functions may present a challenge for policy enforcement. For example, branch-to-branch data traffic may flow over SD-WAN, whereas branch-to-cloud data traffic may routinely use cloud SSE services. In some examples, not all security services or functions are available in both places—within SD-WAN and via SSE. Referring again to FIG. 1A, the network devices 106 available in the SD-WAN 116 may contain a number of types of routers with varying capabilities. Some may be purely routers, some may have firewall (FW) capabilities, some may have next-generation FW (NGFW) capabilities (e.g., FW+IDS/IPS), etc. One or more security policies may govern which security services or functions are expected to be invoked when data traffic goes from one location to another in the network, such as from user device 104(1) to a data center 110 or to another user device 104. The SSE may be able to provide all of the security services suggested in a policy, but some of the security services (e.g., NGFW), may also be available via elements of the SD-WAN 116, such as at a network device 106 or 108. Having a network device 106 or 108 provide a security service may have advantages, and may even be more optimal in some cases.

In the scenario depicted in FIG. 1A, controller device 112 has knowledge of at least some of network devices 106 and 108, and may also know or be able to learn their security capabilities. Controller device 112 may also have access to routing policies for the SD-WAN 116. As such, controller device 112 may know which SD-WAN 116 devices the data traffic might traverse while travelling from a source to a destination. Therefore, controller device 112 is able to determine which devices would be able to provide security services and/or functions suggested in security policy 130. For example, controller device 112 may use knowledge of the SD-WAN 116 and the policy 130 to determine that packet 128 should pass through the SSE 118 on a route to data center 110(2).

Continuing with “Step 2” of FIG. 1A, the communication between network device 106(1) and controller device 112 may include any of a variety of information related to the data traffic, a route of the data traffic, and/or actions applied to the data traffic, such as performing a security function. The communication may include sending a message to the controller device 112 that the packet 128 has been received at network device 106(1). The communication may include relaying route information, intended destination information, information about user device 104(1) (e.g., the sender of packet 128), information about an application associated with the data traffic, or security information. The communication may also include instructions or information sent by controller device 112 to network device 106(1), such as route information, instructions to perform or not perform security functions, information to include when forwarding packet 128 along a route, instructions for handling subsequent packets in the data traffic flow, etc.

At “Step 3” of FIG. 1B, network device 106(1) may send packet 128 to the IDS/IPS 124 and DLP 126 security functions of the SSE 118 before packet 128 continues on a route to network device 108(2). In this example, controller device 112 may have determined that network device 106 is capable of providing a FW security function to packet 128, but not IDS/IPS 124 or DLP 126 type security functions. Controller device 112 may have determined that FW, IDS/IPS, and DLP type security functions are all desired for the data traffic flow represented by packet 128. The determination may have been made by accessing policy 130. Controller device 112 may have sent instructions to network device 106(1) to perform the FW type security function. Controller device 112 may have also sent instructions to network device 106(1) to designate the route to SSE 118, or to provide instructions that are passed along to SSE 118 regarding the desired security functions, and/or other information, such as the destination of packet 128 at data center 110(2), etc. Step 3 includes packet 128 passing through the SSE 118, having the security functions IDS/IPS 124 and DLP 126 performed on the packet 128 at the SSE 118, and the packet 128 continuing on to network device 108(2).

At “Step 4” of FIG. 1B, network device 108(2) may forward packet 128 to data center 110(2). Note that a wide variety of additional functions and/or communications may be performed among the devices of environment 100 relative to packet 128 or any data traffic. For example, network device 108(2) may check that the desired security functions have been completed relative to packet 128 before forwarding packet 128 to data center 110(2). Furthermore, network device 108(2) may communicate with controller device 112 regarding the completion of the security functions, the route of packet 128, etc. Controller device 112 may communicate with SSE 118 to determine capabilities of the SSE 118, capacity of the SSE 118 with respect to timeliness, etc. Communications among the devices of environment 100 may also happen before or after any particular packet of a data traffic flow is sent; communications do not necessarily need to be triggered by the sending of a packet.

At “Step 5” of FIG. 1C, user device 104(1) may send a packet 132 to user device 104(3). The route of packet 132 may include the packet 132 first arriving at network device 106(2). Note that FIG. 1C may represent a separate instance in the scenario illustrated by FIGS. 1A-C. As such, the sending of packet 132 may be independent from the instance involving packet 128, and may occur before, after, or may overlap with the routing of packet 128.

At “Step 6” of FIG. 1C, network device 106(2) may communicate with controller device 112 regarding packet 132. For instance, controller device 112 may determine that data traffic from user device 104(1) to user device 104(3) should be protected by NGFW capabilities. Controller device 112 may determine that network device 106(2) is capable of providing NGFW capabilities. Therefore, controller device 112 may determine that packet 132 is able to bypass the SSE 118, since network device 106(2) is capable of providing the desired security functions. Controller device 112 may instruct network device 106(2) to perform the NGFW security functions on packet 132, and to forward packet 132 to user device 104(3) after the NGFW security functions have been performed, in this instance.

In some examples, controller device 112 may apply security service distribution concepts to applications, rather than particular data traffic or packets. For example, controller device 112 may access security policy information that is to be applied to any data traffic related to a particular application. In this example, controller device 112 may make routing determinations based on the association of data traffic with the particular application. For instance, data traffic related to the particular application may be subjected to the same distribution of security functions as other data traffic related to the same application. The network devices 106 and/or 108 may have standing instructions to apply a firewall type function to any data traffic related to the application, then further instructions to forward the data traffic to the SSE 118 for further security functions. Alternatively, the network devices 106 and/or 108 may have standing instructions to simply forward any data traffic related to the application to the SSE 118 for security services. Application-level distribution may be part of a zero-trust network access (ZTNA) scenario, in some examples.

In order to summarize the scenarios depicted in FIGS. 1A-1C, a general discussion of security service distribution concepts is provided here. Information available to a distributed SASE controller in order to assist security service distribution concepts may include information about SSE security services and/or functions, information about SD-WAN security services (and in particular which SD-WAN routers provide which security services), security services desired for a particular traffic flow (e.g., based on content of the traffic flow, an origination or destination of the traffic flow, or an application with which the traffic flow is associated), SD-WAN routing topology, and in particular which SD-WAN routers a given traffic flow may traverse, etc. The distributed SASE controller may configure the SD-WAN policy-based routing to adhere to the security policies, while also providing for a (potentially) optimal path at the same time. The distributed SASE function may only route traffic through an SSE when needed to adhere to the security policies. One or more security functions may still be provided by the SD-WAN before reaching the SSE, reducing the requested security functions at the SSE.

The distributed SASE controller may configure specific SD-WAN routers to invoke specific security services for specific applications in accordance with the overall security policies. In practice, this may be accomplished at the respective ingress and egress SD-WAN routers for individual sites (i.e., similar to how Security Group Classification may be performed by access switches). In some examples, it may be possible to extend the scheme to additional SD-WAN routers by providing additional context (e.g., source, destination, application, etc.).

The distributed SASE controller may also configure the SSE to invoke only the security services needed when one or more security services has already been provided by the SD-WAN fabric. In practice, this may be accomplished when SD-WAN security services are provided by the ingress and egress SD-WAN routers for individual sites, but it is possible to extend the scheme to cover security services provided by other SD-WAN routers as well.

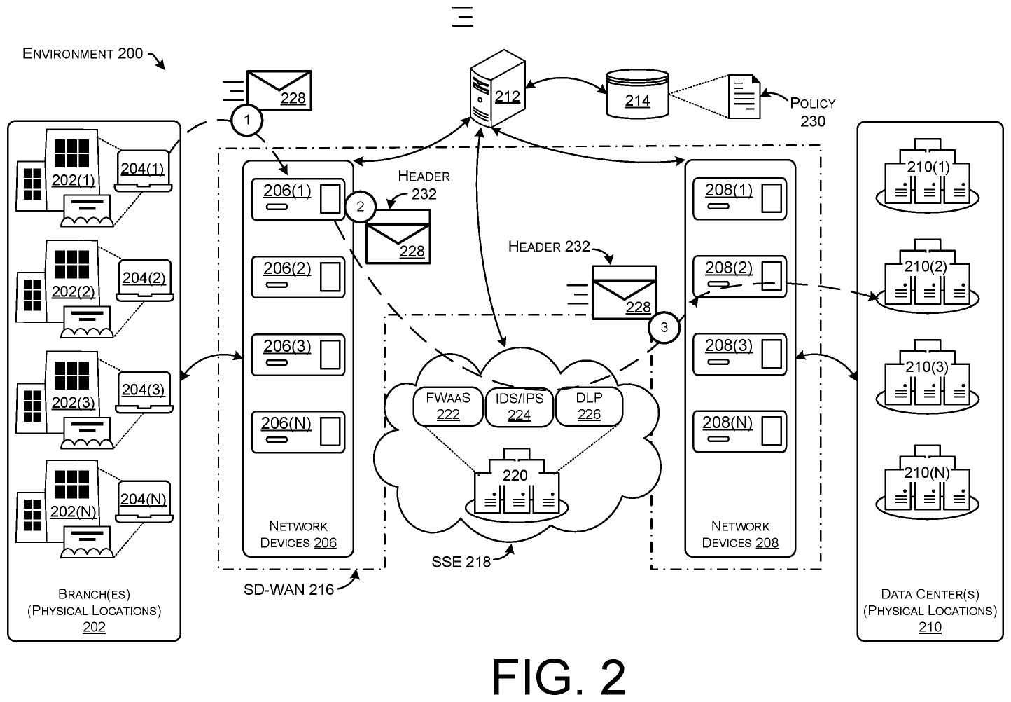

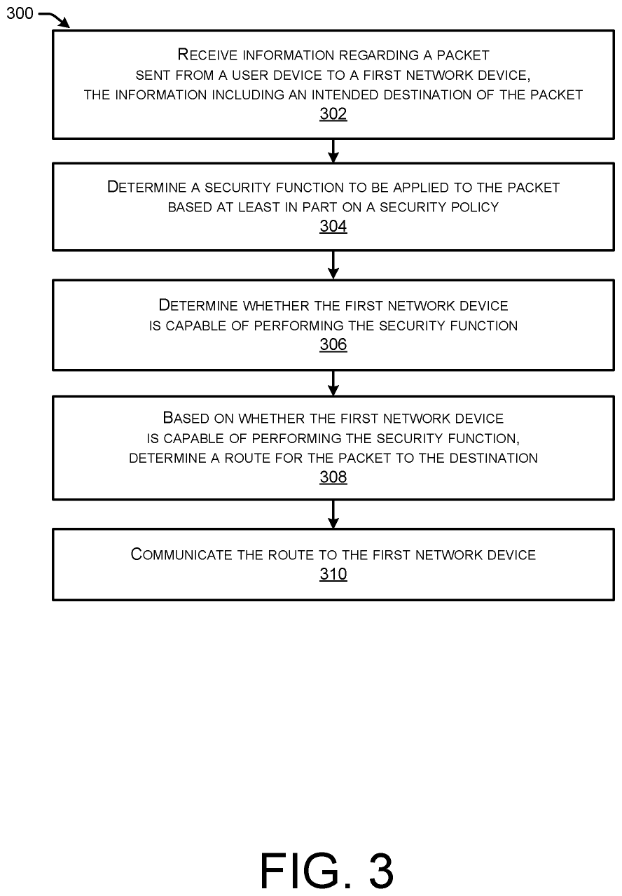

FIGS. 2A, 2B, and 3 collectively illustrate additional example scenarios in accordance with the present security service distribution concepts. FIGS. 2A and 2B illustrate an example environment 200, while FIG. 3 illustrates an example packet with a security service header that relates to the security service distribution concepts illustrated in FIGS. 2A and 2B. Some aspects of the examples shown in FIGS. 2A, 2B, and 3 may be similar to aspects of the examples described above relative to FIGS. 1A-1C. Therefore, for sake of brevity, not all elements of FIGS. 2A, 2B, and 3 will be described in detail.

FIGS. 2A and 2B collectively illustrate an example environment 200 in accordance with the present security service distribution concepts. Example environment 200 may include branches 202, which may include one or more user devices 204 (e.g., computer, laptop, mobile device, tablet, etc.). Environment 200 may also include one or more network devices 206 and 208, one or more data centers 210, a controller device 212, a database 214, an SD-WAN 216, and/or an SSE 218. The SSE 218 may include one or more server devices 220, which may help provide a variety of services, such as FWaaS 222, IDS/IPS 224, DLP 226, and/or other types of services.

At “Step 1” of FIG. 2, user device 204(1) may send a packet 228 to network device 206(1). The packet 228 may be a part of a data traffic flow sent by user device 204(1) to another device in environment 200. For example, an intended destination for the data traffic flow may be data center 210(2). In some examples, the data traffic flow may be subject to a policy, such as policy 230.

At “Step 2,” network device 204(1) may add header 232 to packet 228 (or edit a header 232 of packet 228, etc.). The header 232 may provide a variety of information related to security service distribution concepts. For example, the header 232 may include information regarding one or more desired security functions for packet 228. Network device 204(1) may perform a particular security function on packet 228, and may add information regarding the completion of the particular security function to header 232, in some cases.

At “Step 3,” packet 228 may continue along the route to SSE 218, to network device 208(2), and to data center 210(2). Note that packet 228 is carrying header 232 along the route. Therefore, devices along the route, such as a server device 220 and/or network device 208(2) may be able to access information contained in header 232, and may also edit information contained in header 232, such as information regarding one or more security functions that are desired or have been applied to packet 228 along the route.

In some examples, the scenario depicted in FIG. 2 describes a method for security service distribution in which the distribution is not fully orchestrated by a central controller (e.g., controller device 212). In this scenario, the data plane may be extended to include information about the security services needed for a given traffic flow. When data traffic enters SD-WAN 216, the overlay network may add this information to packet 228. For instance, information may be added to header 232 (e.g., a VXLAN header). As such, header 232 may be referred to as a Security Service Header. Header 232 may include information about specific services which are desired to be applied for a given flow. For example, if policy 230 dictates that the flow be treated first with NGFW, then DLP, this may be indicated in header 232 such that when it arrives in the SSE 218, the header instructs the SSE 218 how to handle the flow. In this way the security service policy for a given traffic flow is determined a-priori and subsequently signaled in-band upon entering the SD-WAN 216 as opposed to when entering the SSE 218, thereby forming a distributed SASE fabric. Stated another way, controller device 212 may be in communication with network devices 206 and 208 and/or SSE 218, and may be sending and/or receiving information regarding a security policy relevant to data traffic flow that includes packet 228, but the specific routing of packet 228 may be able to be determined by network device 206(1), SSE 218, and/or network device 208(2) without specific instructions from controller device 212.

In one embodiment, the security services required for a device, user, or application may be determined directly at the endpoint (e.g., user device 204(1)). For example, a security solution (Cisco Advanced Malware Protection (AMP) for endpoints, Cisco Secure Endpoint, Cisco unified client, etc.) may have the ability to examine traffic flows and through a central security policy (e.g., policy 230), determine what security functions must be applied to the data traffic flow (including packet 228). Thus, at the endpoint itself (e.g., user device 204(1)), an ordered list of desired security functions may be written into header 232 as metadata (e.g., IPv6 extension headers, etc.) that allow the rest of the network (e.g., SD-WAN 216) to know what must be applied to the packet 228 and/or data traffic flow before exiting the network to the destination (e.g., to data center 210(2)). Note that in this embodiment, the header would be attached to packet 228 in Step 1 of the example scenario shown in FIG. 2.

In scenarios where information is provided by an endpoint (e.g., a user device 204), it may be important to determine the trustworthiness of such information. For this reason, a Zero Trust based approach may be applied, where a trust score for the endpoint is determined and signaled to the network entry point (e.g. network device 206, access switch, SD-WAN router, SSE head-end for ZTNA, etc.). If the trust score is sufficiently high, the header 232 provided by the endpoint may be used. If the trust score is not sufficiently high, a new header may be provided and used instead.

As traffic traverses the distributed SASE (e.g., SD-WAN 216 and SSE 218) fabric, devices and/or security services may look for the in-band Security Service Header (e.g., header 232) to determine whether to invoke a particular security function for a given traffic flow (as opposed to relying on controller device 212 informing the devices/services out-of-band). When a security function is performed, the completed function may be marked as such in the header 232, thereby avoiding redundant invocations of the same security function by different entities on the route. In this manner, duplication of services may be decreased or prevented.

Another benefit of this approach is that the header 232 may provide an audit mechanism. Once packet 228 leaves the SD-WAN 216 (leaves the distributed SASE fabric), the exit SD-WAN router (e.g., network device 208(2)) can check the Security Service Header (e.g., header 232) to verify that all required security functions have in fact been performed. If they have not, the exit router can take an action, such as redirecting the flow to the SSE 218 to invoke the missing security function. A loop detection and prevention mechanism may furthermore be added to prevent infinite loops. For example, a generic hop-counter or an SSE redirect counter may be added.

To summarize, the security service distribution techniques described herein may improve network performance. The techniques may allow a more optimized distribution of the application of security functions to a data traffic flow. The techniques may help prevent unnecessary increases in latency or cost from sending too much data traffic to a SSE type service. Furthermore, the techniques may prevent redundancy of security functions along a route.

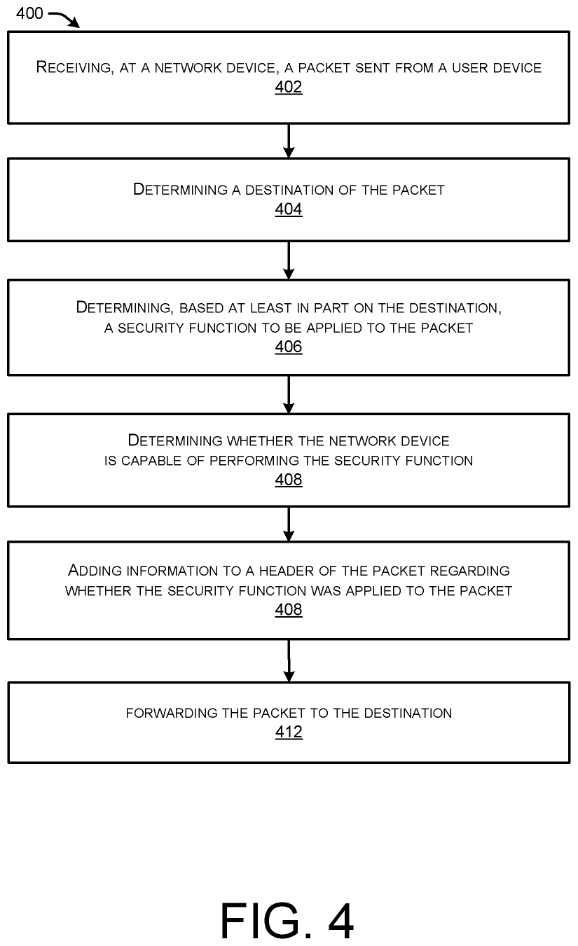

FIGS. 3 and 4 illustrate flow diagrams of example methods 300 and 400 that include functions that may be performed at least partly by a controller device, such as controller device 112, and/or a network device, such as network device 206(1), described relative to FIGS. 1A-2. The logical operations described herein with respect to FIGS. 3 and 4 may be implemented (1) as a sequence of computer-implemented acts or program modules running on a computing system and/or (2) as interconnected machine logic circuits or circuit modules within the computing system. In some examples, the method(s) 300 and/or 400 may be performed by a system comprising one or more processors and one or more non-transitory computer-readable media storing computer-executable instructions that, when executed by the one or more processors, cause the one or more processors to perform the method(s) 300 or 400.

The implementation of the various devices and/or components described herein is a matter of choice dependent on the performance and other requirements of the computing system. Accordingly, the logical operations described herein are referred to variously as operations, structural devices, acts, or modules. These operations, structural devices, acts, and modules may be implemented in software, in firmware, in special purpose digital logic, and any combination thereof. It should also be appreciated that more or fewer operations might be performed than shown in the FIGS. 3 and 4 and described herein. These operations may also be performed in parallel, or in a different order than those described herein. Some or all of these operations may also be performed by components other than those specifically identified. Although the techniques described in this disclosure is with reference to specific devices, in other examples, the techniques may be implemented by less devices, more devices, different devices, or any configuration of devices and/or components.

FIG. 3 illustrates a flow diagram of an example method 300 for network devices to perform security service distribution techniques. Method 300 may be performed by a controller device (e.g., controller device 112) communicatively coupled to a network device (e.g., network device 106), for instance.

At 302, method 300 may include receiving, at a controller device, information regarding a packet sent from a user device to a network device. The information may include an intended destination of the packet. In some examples, the network device may be included in a software defined wide area network (SD-WAN) of an organization.

At 304, method 300 may include determining, by the controller device, a security function to be applied to the packet. Determination of the security function may be based at least in part on a security policy. The determination may also be based at least in part on the intended destination of the packet.

At 306, method 300 may include determining, by the controller device, whether the network device is capable of performing the security function. In some examples, method 300 may further include causing the network device to add information to a header of the packet. For instance, the information may indicate that the network device successfully performed or did not perform the security function on the packet. In an instance where a security function is desired, method 300 may include causing additional information to be added to the header of the packet indicating a security function to be performed on the packet by another network device. In this instance, the packet may be received by another network device which would find out from the header that the security function was desired, and potentially be able to perform the requested security function.

At 308, based on whether the network device is capable of performing the security function, method 300 may include determining, by the controller device, a route for the packet to the destination. For instance, in an instance in which the controller device determines that the network device is capable of performing the security function, the route may proceed relatively directly to the intended destination. However, in another instance in which the controller device determines that the network device is not capable of performing the security function, the route determined by the controller device may include sending the packet to a security service that is capable of performing the security function, for the purpose of having the security function performed before the packet may be forwarded to the intended destination. The security service may be external to the SD-WAN of the organization, for instance.

In some examples, method 300 may further include determining, by the controller device, that the security service is capable of providing the security function. Determination that the security service is capable of providing the security function may therefore influence the determination by the controller device to send the packet to the security service. Additionally or alternatively, method 300 may further include determining, by the controller device, a cost for a security service to perform the security function on the packet. Determination of a cost of the security service may therefore influence the determination by the controller device to send the packet to the security service. In yet another example, method 300 may further include determining, by the controller device, an increase in latency that would be caused by sending the packet to a security service for the security service to perform the security function on the packet. Here again, determination of an increase in latency of the security service may therefore influence the determination by the controller device to send the packet to the security service.

At 310, method 300 may include communicating, by the controller device, the route to the network device. Method 300 may also include causing the network device to forward the packet along the determined route.

FIG. 4 illustrates a flow diagram of an example method 400 for network devices to perform security service distribution techniques. Method 400 may be performed by a network device (e.g., network device 206(1) communicatively coupled to other devices associated with a network (e.g., a user device 204, any devices of SD-WAN 216 or SSE 218), for instance.

At 402, method 400 may include receiving, at the network device, a packet sent from a user device. The packet may or may not have a header at this point that includes information relevant to security service distribution techniques.

At 404, method 400 may include determining a destination of the packet. Determining a destination of the packet may include determining a route that the packet may need to take to reach the destination. For instance, the determination may include realizing that the packet will pass out of a SD-WAN of an organization, or other trusted sphere.

At 406, based at least in part on the destination, method 400 may include determining a security function to be applied to the packet. The security function may be determined based on realizing that the packet will pass out of the SD-WAN of the organization, and that the information contained in the packet or associated data traffic flow may need to be protected.

At 408, method 400 may include determining whether the network device is capable of performing the security function. In an instance where the network device is capable of performing the security function, method 400 may include the network device performing the security function.

At 410, method 400 may include adding information to a header of the packet regarding whether the security function was applied to the packet. For instance, where the network device is capable of performing the security function and is able to successfully complete the security function, information indicating the completion of the security function may be added to the packet by the network device. In another instance in which the network device is not capable of performing the security function successfully, the information added to the header of the packet may indicate that the security function was not performed by the network device. In this instance, method 400 may further comprise routing the packet to a security service that is capable of performing the security function before the packet is forwarded on toward the destination. Note that method 400 may further include determining that the security service is able to perform the security function, since routing the packet to a security service may be based at least in part on the security service being capable of performing the security function.

At 412, method 400 may include forwarding the packet to the destination. Note that there may be multiple potential routes for the packet to proceed to the destination. The route may include passing through a security service on the path to the destination. Aside from security service distribution considerations, the routing may also be influenced by traditional routing choices such as latency, cost, bandwidth, geography, etc.

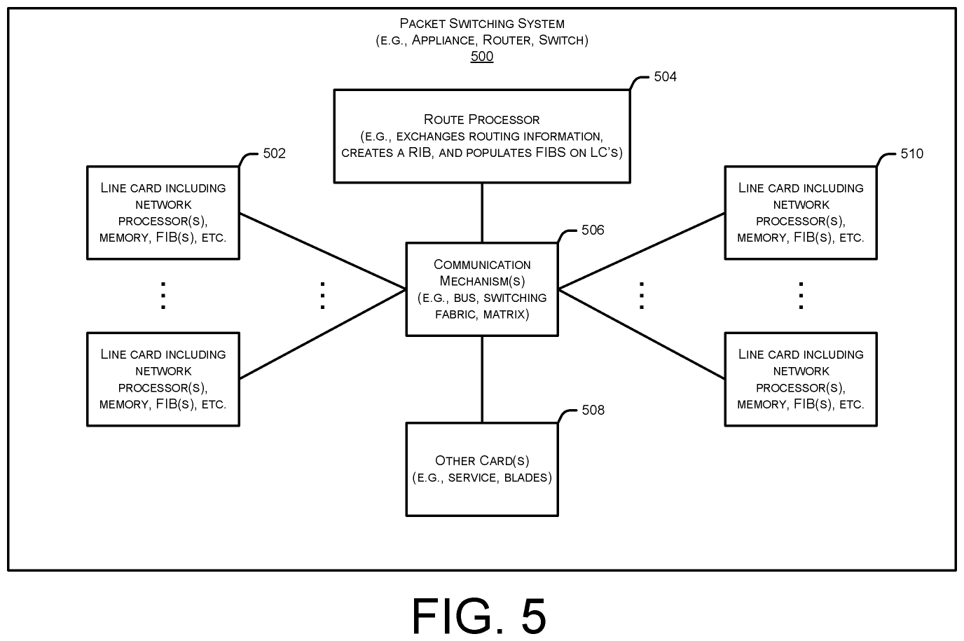

FIG. 5 illustrates a block diagram illustrating an example packet switching device (or system) 400 that can be utilized to implement various aspects of the technologies disclosed herein. In some examples, packet switching device(s) 500 may be employed in various networks, such as, for example, SD-WAN 116 or 216 as described with respect to FIGS. 1A-2.

In some examples, a packet switching device 500 may comprise multiple line card(s) 502, 510, each with one or more network interfaces for sending and receiving packets over communications links (e.g., possibly part of a link aggregation group). The packet switching device 500 may also have a control plane with one or more processing elements 504 for managing the control plane and/or control plane processing of packets associated with forwarding of packets in a network. The packet switching device 500 may also include other cards 508 (e.g., service cards, blades) which include processing elements that are used to process (e.g., forward/send, drop, manipulate, change, modify, receive, create, duplicate, apply a service) packets associated with forwarding of packets in a network. The packet switching device 500 may comprise hardware-based communication mechanism 506 (e.g., bus, switching fabric, and/or matrix, etc.) for allowing its different entities 502, 504, 508 and 510 to communicate. Line card(s) 502, 510 may typically perform the actions of being both an ingress and/or an egress line card 502, 510, in regard to multiple other particular packets and/or packet streams being received by, or sent from, packet switching device 500.

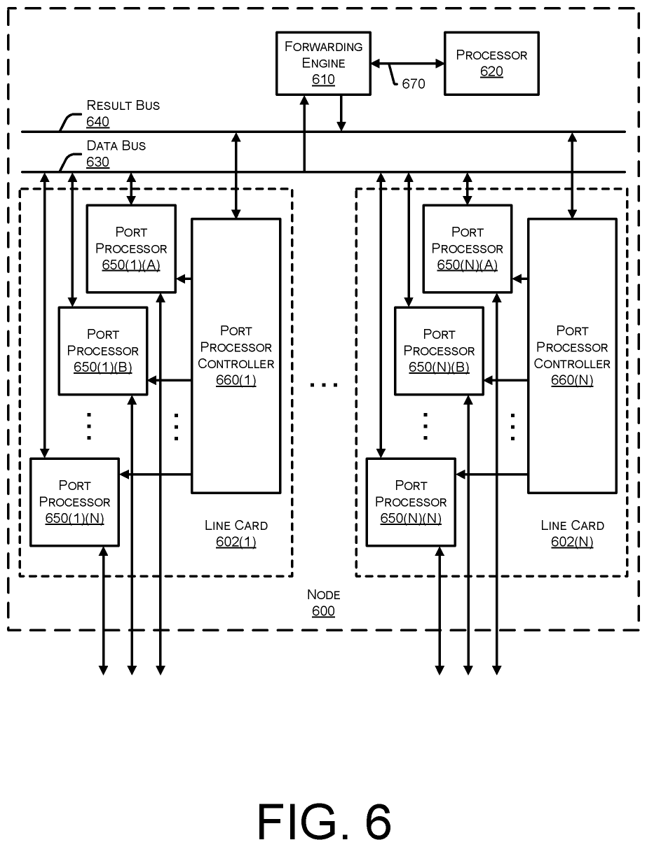

FIG. 6 illustrates a block diagram illustrating certain components of an example node 600 that can be utilized to implement various aspects of the technologies disclosed herein. In some examples, node(s) 600 may be employed in various networks, such as, for example, SD-WAN 116 or 216 as described with respect to FIGS. 1A-2.

In some examples, node 600 may include any number of line cards 602 (e.g., line cards 602(1)-(N), where N may be any integer greater than 1) that are communicatively coupled to a forwarding engine 610 (also referred to as a packet forwarder) and/or a processor 620 via a data bus 630 and/or a result bus 640. Line cards 602(1)-(N) may include any number of port processors 650(1)(A)-(N)(N) which are controlled by port processor controllers 660(1)-(N), where N may be any integer greater than 1. Additionally, or alternatively, forwarding engine 610 and/or processor 620 are not only coupled to one another via the data bus 630 and the result bus 640, but may also communicatively coupled to one another by a communications link 670.

The processors (e.g., the port processor(s) 650 and/or the port processor controller(s) 660) of each line card 602 may be mounted on a single printed circuit board. When a packet or packet and header are received, the packet or packet and header may be identified and analyzed by node 600 (also referred to herein as a router) in the following manner. Upon receipt, a packet (or some or all of its control information) or packet and header may be sent from one of port processor(s) 650(1)(A)-(N)(N) at which the packet or packet and header was received and to one or more of those devices coupled to the data bus 630 (e.g., others of the port processor(s) 650(1)(A)-(N)(N), the forwarding engine 610 and/or the processor 620). Handling of the packet or packet and header may be determined, for example, by the forwarding engine 610. For example, the forwarding engine 610 may determine that the packet or packet and header should be forwarded to one or more of port processors 650(1)(A)-(N)(N). This may be accomplished by indicating to corresponding one(s) of port processor controllers 660(1)-(N) that the copy of the packet or packet and header held in the given one(s) of port processor(s) 650(1)(A)-(N)(N) should be forwarded to the appropriate one of port processor(s) 650(1)(A)-(N)(N). Additionally, or alternatively, once a packet or packet and header has been identified for processing, the forwarding engine 610, the processor 620, and/or the like may be used to process the packet or packet and header in some manner and/or maty add packet security information in order to secure the packet. On a node 600 sourcing such a packet or packet and header, this processing may include, for example, encryption of some or all of the packet's or packet and header's information, the addition of a digital signature, and/or some other information and/or processing capable of securing the packet or packet and header. On a node 600 receiving such a processed packet or packet and header, the corresponding process may be performed to recover or validate information of the packet and/or header that has been secured.

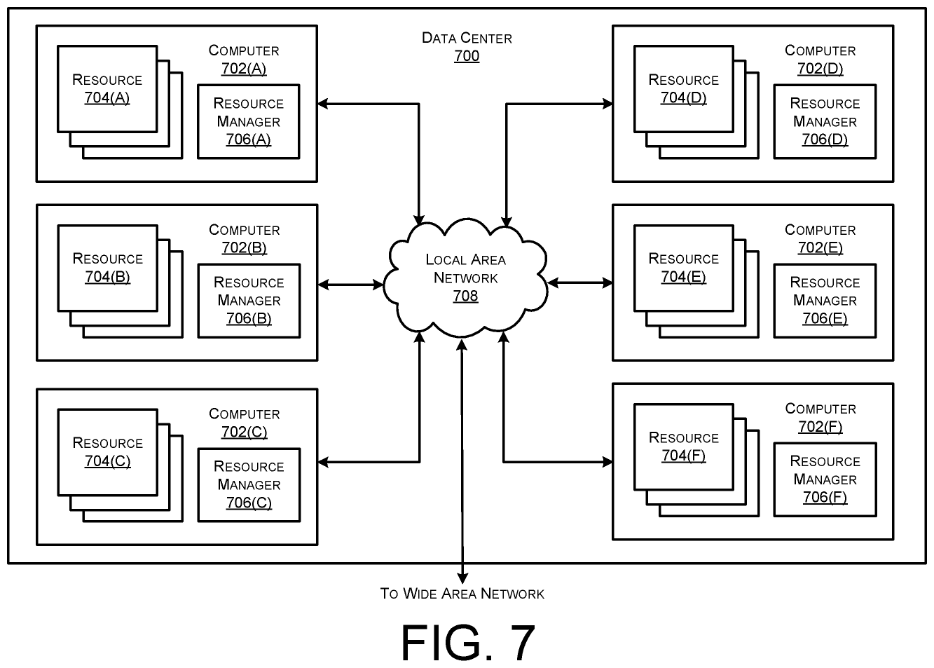

FIG. 7 is a computing system diagram illustrating a configuration for a data center 700 that can be utilized to implement aspects of the technologies disclosed herein. The example data center 700 shown in FIG. 7 includes several computers 702A-702F (which might be referred to herein singularly as “a computer 702” or in the plural as “the computers 702”) for providing computing resources. In some examples, the resources and/or computers 702 may include, or correspond to, any type of networked device described herein, such as controller device 112 or 212, or any network devices 106, 108, 206, and 208 of SD-WAN 116/216. Although, computers 702 may comprise any type of networked device, such as servers, switches, routers, hubs, bridges, gateways, modems, repeaters, access points, hosts, etc.

The computers 702 can be standard tower, rack-mount, or blade server computers configured appropriately for providing computing resources. In some examples, the computers 702 may provide computing resources 704 including data processing resources such as virtual machine (VM) instances or hardware computing systems, database clusters, computing clusters, storage clusters, data storage resources, database resources, networking resources, and others. Some of the computers 702 can also be configured to execute a resource manager 706 capable of instantiating and/or managing the computing resources. In the case of VM instances, for example, the resource manager 706 can be a hypervisor or another type of program configured to enable the execution of multiple VM instances on a single computer 702. Computers 702 in the data center 700 can also be configured to provide network services and other types of services.

In the example data center 700 shown in FIG. 7, an appropriate local area network (LAN) 708 is also utilized to interconnect the computers 702A-702F. It should be appreciated that the configuration and network topology described herein has been greatly simplified and that many more computing systems, software components, networks, and networking devices can be utilized to interconnect the various computing systems disclosed herein and to provide the functionality described above. Appropriate load balancing devices or other types of network infrastructure components can also be utilized for balancing a load between data centers 700, between each of the computers 702A-702F in each data center 700, and, potentially, between computing resources in each of the computers 702. It should be appreciated that the configuration of the data center 700 described with reference to FIG. 7 is merely illustrative and that other implementations can be utilized.

In some examples, the computers 702 may each execute one or more application containers and/or virtual machines to perform techniques described herein. For instance, the containers and/or virtual machines may serve as server devices, user devices, and/or routers in the cloud computing network SSE 118 or 218.

In some instances, the data center 700 may provide computing resources, like application containers, VM instances, and storage, on a permanent or an as-needed basis. Among other types of functionality, the computing resources provided by a cloud computing network may be utilized to implement the various services and techniques described above. The computing resources 704 provided by the cloud computing network can include various types of computing resources, such as data processing resources like application containers and VM instances, data storage resources, networking resources, data communication resources, network services, and the like.

Each type of computing resource 704 provided by the cloud computing network can be general-purpose or can be available in a number of specific configurations. For example, data processing resources can be available as physical computers or VM instances in a number of different configurations. The VM instances can be configured to execute applications, including web servers, application servers, media servers, database servers, some or all of the network services described above, and/or other types of programs. Data storage resources can include file storage devices, block storage devices, and the like. The cloud computing network can also be configured to provide other types of computing resources 704 not mentioned specifically herein.

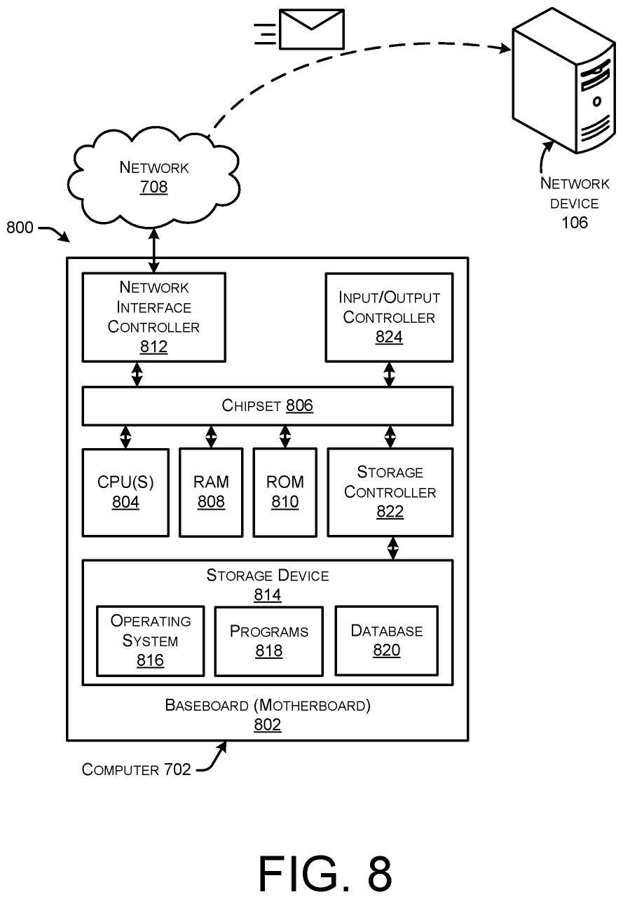

The computing resources 704 provided by a cloud computing network may be enabled in one embodiment by one or more data centers 700 (which might be referred to herein singularly as “a data center 700” or in the plural as “the data centers 700”). The data centers 700 are facilities utilized to house and operate computer systems and associated components. The data centers 700 typically include redundant and backup power, communications, cooling, and security systems. The data centers 700 can also be located in geographically disparate locations. One illustrative embodiment for a data center 700 that can be utilized to implement the technologies disclosed herein will be described below with regards to FIG. 8.

FIG. 8 shows an example computer architecture 800 for a computer 702 capable of executing program components for implementing the functionality described above. The computer architecture 800 shown in FIG. 8 illustrates a conventional server computer, workstation, desktop computer, laptop, tablet, network appliance, e-reader, smartphone, and/or other computing device, and can be utilized to execute any of the software components presented herein. The computer 702 may, in some examples, correspond to a physical device described herein (e.g., user device, network device, controller device, server device, etc.), and may comprise networked devices such as servers, switches, routers, hubs, bridges, gateways, modems, repeaters, access points, etc. For instance, computer 702 may correspond to controller device 112 or 212.

As shown in FIG. 8, the computer 702 includes a baseboard 802, or “motherboard,” which is a printed circuit board to which a multitude of components or devices can be connected by way of a system bus or other electrical communication paths. In one illustrative configuration, one or more central processing units (“CPUs”) 804 operate in conjunction with a chipset 806. The CPUs 804 can be standard programmable processors that perform arithmetic and logical operations necessary for the operation of the computer 702.

The CPUs 804 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 806 provides an interface between the CPUs 804 and the remainder of the components and devices on the baseboard 802. The chipset 806 can provide an interface to a RAM 808, used as the main memory in the computer 702. The chipset 806 can further provide an interface to a computer-readable storage medium such as a read-only memory (“ROM”) 810 or non-volatile RAM (“NVRAM”) for storing basic routines that help to startup the computer 702 and to transfer information between the various components and devices. The ROM 810 or NVRAM can also store other software components necessary for the operation of the computer 702 in accordance with the configurations described herein.

The computer 702 can operate in a networked environment using logical connections to remote computing devices and computer systems through a network, such as SD-WAN 116 and/or 216 or network 708. The chipset 806 can include functionality for providing network connectivity through a network interface controller (NIC) 812, such as a gigabit Ethernet adapter. The NIC 812 is capable of connecting the computer 702 to other computing devices over the network 708. For instance, in the example shown in FIG. 8, NIC 812 may help facilitate transfer of data, packets, and/or communications (indicated by the envelope in FIG. 8) over the SD-WAN 116 with a network device 106. It should be appreciated that multiple NICs 812 can be present in the computer 702, connecting the computer to other types of networks and remote computer systems.

The computer 702 can be connected to a storage device 814 that provides non-volatile storage for the computer. The storage device 814 can store an operating system 816, programs 818, policy 130 or 230, and/or other data. The storage device 814 can be connected to the computer 702 through a storage controller 822 connected to the chipset 806, for example. The storage device 814 can consist of one or more physical storage units. The storage controller 822 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 702 can store data on the storage device 814 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 814 is characterized as primary or secondary storage, and the like.

For example, the computer 702 can store information to the storage device 814 by issuing instructions through the storage controller 822 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 702 can further read information from the storage device 814 by detecting the physical states or characteristics of one or more particular locations within the physical storage units.

In addition to the mass storage device 814 described above, the computer 702 can have access to other computer-readable storage media to store and retrieve information, such as policies, program modules, data structures, and/or other data. It should be appreciated by those skilled in the art that computer-readable storage media is any available media that provides for the non-transitory storage of data and that can be accessed by the computer 702. In some examples, the operations performed by the SD-WAN 116 or 216, and or any components included therein, may be supported by one or more devices similar to computer 702. Stated otherwise, some or all of the operations performed by the SD-WAN 116 or 216, and or any components included therein, may be performed by one or more computer devices 702 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“IHD-DVD”), BLU-RAY, ternary content addressable memory (TCAM), and/or other optical storage, magnetic cassettes, magnetic tape, magnetic disk storage or other magnetic storage devices, or any other medium that can be used to store the desired information in a non-transitory fashion.

As mentioned briefly above, the storage device 814 can store an operating system 816 utilized to control the operation of the computer 702. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 814 can store other system or application programs and data utilized by the computer 702.

In one embodiment, the storage device 814 or other computer-readable storage media is encoded with computer-executable instructions which, when loaded into the computer 702, transform the computer from a general-purpose computing system into a special-purpose computer capable of implementing the embodiments described herein. These computer-executable instructions transform the computer 702 by specifying how the CPUs 804 transition between states, as described above. According to one embodiment, the computer 702 has access to computer-readable storage media storing computer-executable instructions which, when executed by the computer 702, perform the various processes described above with regards to FIGS. 1A-4. The computer 702 can also include computer-readable storage media having instructions stored thereupon for performing any of the other computer-implemented operations described herein.

The computer 702 can also include one or more input/output controllers 824 for receiving and processing input from a number of input devices, such as a keyboard, a mouse, a touchpad, a touch screen, an electronic stylus, or other type of input device. Similarly, an input/output controller 824 can provide output to a display, such as a computer monitor, a flat-panel display, a digital projector, a printer, or other type of output device. It will be appreciated that the computer 702 might not include all of the components shown in FIG. 8, can include other components that are not explicitly shown in FIG. 8, or might utilize an architecture completely different than that shown in FIG. 8.

As described herein, the computer 702 may comprise one or more devices, such as a network device 106, 108, 206, or 208, user devices 104 or 204, controller device 112 or 212, and/or other devices. The computer 702 may include one or more hardware processors 804 (processors) configured to execute one or more stored instructions. The processor(s) 804 may comprise one or more cores. Further, the computer 702 may include one or more network interfaces configured to provide communications between the computer 702 and other devices, such as the communications described herein as being performed by controller devices 112 or 212 and network devices 106, 108, 206, or 208, and/or other devices. In some examples, the communications may include data, packet, instructions, policy, and/or other information transfer, for instance. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 818 may comprise any type of programs or processes to perform the techniques described in this disclosure in accordance with security service distribution techniques. For instance, the programs 818 may cause the computer 702 to perform techniques for communicating with other devices using any type of protocol or standard usable for determining connectivity. Additionally, the programs 818 may comprise instructions that cause the computer 702 to perform the specific techniques for security service distribution.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative of some embodiments that fall within the scope of the claims of the application.

What is claimed is:

1. A computer-implemented method comprising:
receiving, at a controller device, information regarding a packet sent from a user device to a network device, the information including an intended destination of the packet;
determining, by the controller device, a security function to be applied to the packet based at least in part on a security policy and the intended destination;
determining, by the controller device, whether the network device is capable of performing the security function;
based on whether the network device is capable of performing the security function, determining, by the controller device, a route for the packet to the intended destination; and
communicating, by the controller device, the route to the network device.

2. The computer-implemented method of claim 1, wherein, in an instance in which the controller device determines that the network device is not capable of performing the security function, the route determined by the controller device includes sending the packet to a security service that is capable of performing the security function.

3. The computer-implemented method of claim 2, further comprising:
determining, by the controller device, that the security service is capable of providing the security function.

4. The computer-implemented method of claim 3, wherein the network device is included in a software defined wide area network (SD-WAN) of an organization and the security service is external to the SD-WAN of the organization.

5. The computer-implemented method of claim 1, wherein determining the route is further based at least part on determining, by the controller device, a cost for a security service to perform the security function on the packet.

6. The computer-implemented method of claim 1, wherein determining the route is further based at least part on determining, by the controller device, an increase in latency that would be caused by sending the packet to a security service for the security service to perform the security function on the packet.

7. The computer-implemented method of claim 1, wherein, in an instance in which the controller device determines that the network device is capable of performing the security function, the computer-implemented method further comprises:
causing the network device to add information to a header of the packet, the information indicating that the network device performed the security function on the packet.

8. The computer-implemented method of claim 7, further comprising:
causing additional information to be added to the header of the packet indicating a second security function to be performed on the packet by a second network device.

9. A controller device comprising:
one or more processors; and
one or more non-transitory computer-readable media storing computer-executable instructions that, when executed by the one or more processors, cause the one or more processors to:
receive information regarding a packet sent from a user device to a first network device, the information including an intended destination of the packet;
determine a security function to be applied to the packet based at least in part on a security policy;
determine whether the first network device is capable of performing the security function; and
based on whether the first network device is capable of performing the security function, determine a route for the packet to the intended destination; and
communicate the route to the first network device.

10. The controller device of claim 9, wherein, in an instance in which the first network device is not capable of performing the security function, the route includes sending the packet to a security service that is capable of performing the security function.

11. The controller device of claim 10, wherein the computer-executable instructions further cause the one or more processors to:
determine that the security service is capable of providing the security function.

12. The controller device of claim 11, wherein the first network device is included in a software defined wide area network (SD-WAN) of an organization and the security service is external to the SD-WAN of the organization.

13. The controller device of claim 9, wherein determining the route is further based at least part on determining a cost for a security service to perform the security function on the packet.

14. The controller device of claim 9, wherein determining the route is further based at least part on determining an increase in latency that would be caused by sending the packet to a security service for the security service to perform the security function on the packet.

15. The controller device of claim 9, wherein, in an instance in which the first network device is capable of performing the security function, the computer-executable instructions further cause the one or more processors to:
cause the first network device to add information to a header of the packet, the information indicating that the first network device performed the security function on the packet.

16. The controller device of claim 15, wherein the computer-executable instructions further cause the one or more processors to:
cause additional information to be added to the header of the packet indicating a second security function to be performed on the packet by a second network device.

17. A method comprising:
receiving, at a network device, a packet sent from a user device;
determining a destination of the packet;
determining, based at least in part on the destination, a security function to be applied to the packet;
determining whether the network device is capable of performing the security function;
adding information to a header of the packet regarding whether the security function was applied to the packet; and
forwarding the packet to the destination.

18. The method of claim 17, further comprising:
in a first instance, where the network device is capable of performing the security function, performing, by the network device, the security function, wherein the information added to the header of the packet indicates that the security function was performed by the network device.

19. The method of claim 18, wherein, in a second instance in which the network device is not capable of performing the security function, the information added to the header of the packet indicates that the security function was not performed by the network device, and the method further comprises:
routing the packet to a security service before the destination.

20. The method of claim 19, further comprising:
determining that the security service is able to perform the security function, wherein the routing the packet to the security service is based at least in part on the security service being capable of performing the security function.
